(19) United States
(12) Patent Application Publication
(10) Pub. No.: US 2010/0153401 A1
(43) Pub. Date: Jun. 17, 2010

(54) DATA CLASSIFICATION SYSTEM

(76) Inventors: Michael D. Stovsky, Beachwood, OH (US); Wayne M. Serra, Avon Lake, OH (US); Shawn R. Russell, Changrin Falls, OH (US)

Correspondence Address: ULMER & BERNE LLP;ATTN: DIANE BELL, 600 VINE STREET, SUITE 2800, CINCINNATI, OH, 45202, US

(21) Appl. No.: 12/307,689

(22) PCT Filed: Jul. 6, 2007
(86) PCT No.: PCT/US07/15625

§ 371 Date: Aug. 10, 2009

Related U.S. Application Data
(60) Provisional application No. 60/818,889, filed on Jul. 6, 2006.
(60) Provisional application No. 60/840,329, filed on Aug. 25, 2006.

(51) Int. Cl. G06F 17/30

(52) U.S. Cl. 707/740; 707/802; 707/E17.09; 707/E17.044; 707/737; 707/E17.005

(57) ABSTRACT

A system for classifying information comprises a group of at least four impact factors that includes confidentiality, legal applicability, integrity, and availability (130,140,150,160). The system also includes an impact level assigned to at least one impact factor in the group of at least four impact factors; and a classification level based upon a set of zero or more impact factors from the group of at least four impact factors. Inclusion of each impact factor in the set of zero or more impact factors is based at least in part upon a comparison of the impact level assigned to each impact factor to a predetermined impact level. Methods of using the system are also provided.

### REFERENCE TO RELATED APPLICATIONS

This application claims priority to U.S. Provisional Application Ser. No. 60/818,889 filed Jul. 6, 2006 and hereby incorporates that application by reference. This application additionally claims priority to U.S. Provisional Application Ser. No. 60/840,329 filed Aug. 25, 2006 and hereby incorporates that application by reference.

### TECHNICAL FIELD

The disclosed systems and methods relate generally to the field of information management and more specifically to systems and methods for classifying and controlling information.

### BACKGROUND

In the course of daily operation, entities (e.g., individuals, organizations, groups, governmental entities, corporations, or the like) may collect, maintain, share or otherwise handle a great deal of information. While some information may have relatively little to no impact on the entity if publicly disclosed, or may in fact be intended for disclosure to the general public, (e.g., press releases), other information may be highly sensitive (e.g., trade secrets). Unwitting or unintentional disclosure of sensitive information may be harmful to reputations, business interests, employees, or otherwise. Disclosure of some information may also be contrary to law.

To ensure that information is properly maintained or disclosure properly controlled, an information classification system may be implemented. For example, the United States government has implemented an information classification system that classifies information as confidential, secret, or top secret. In the U.S. government classification system, each level of classification indicates an increasing degree of sensitivity (i.e., access to information is increasingly more restricted). Under the U.S. government's system, persons or groups may access information only when there is a need to know such information coupled with an appropriate a security clearance (i.e., a person or group is permitted to access information having a particular classification). The U.S. government's system, however, is limited to these three classifications and relies on human intervention to properly classify information.

### SUMMARY

A system for classifying information comprises a group of at least four impact factors, an impact level, and a classification level. The group of at least four impact factors includes confidentiality, legal applicability, integrity, and availability. The impact level is assigned to at least one impact factor in the group of at least four impact factors. The classification level is based upon a set of zero or more impact factors from the group of at least four impact factors. Inclusion of each impact factor in the set of zero or more impact factors is based at least in part upon a comparison of the impact level assigned to each impact factor to a predetermined impact level.

A data structure for storing classified data comprises an information field, a classification field, and a factor field. The information field is configured to store classified information. The classification field is configured to store an indicator of a classification assigned to the classified information. The factor field is configured to store at least one indicator of an impact factor that is selected from a group that includes confidentiality, legal protection, integrity, and availability. The factor field is also associated with the classification assigned to the classified information.

A computer-readable medium comprises a data structure for storing classified data. The data structure includes an information field, a classification field, and a factor field. The information field is configured to store classified information. The classification field is configured to store an indicator of a classification assigned to the classified information. The factor field configured to store at least one indicator of an impact factor that is selected from a group that includes confidentiality, legal protection, integrity, and availability. The factor field is also associated with the classification assigned to the classified information.

A manufacture comprises a data signal embodied in a communication medium that includes a data structure for storing classified data. The data structure includes an information field, a classification field, and a factor field. The information field is configured to store classified information. The classification field is configured to store an indicator of a classification assigned to the classified information. The factor field is configured to store at least one indicator of an impact factor that is selected from a group that includes confidentiality, legal protection, integrity, and availability. The factor field is also associated with the classification assigned to the classified information.

A system for classifying information in electronic formats comprises an impact factor module, a categorization module, and a classification module. The impact factor module is configured to provide a designation of zero or more impact factors associated with a piece of information. The categorization module is in data communication with the impact factor module that is configured to select a classification for the piece of information based at least in part upon the designation of zero or more impact factors. The classification module is configured to assign a selected classification to a piece of information.

A method for classifying information is provided. The method comprises assigning an impact level to at least one impact factor of a group of at least four impact factors that includes confidentiality, legal applicability, integrity, and availability. The method further comprises creating a set of zero or more impact factors of the group of at least four impact factors that have greater than a predetermined impact level. The method additionally comprises selecting a classification level based at least in part upon a mapping of the created set of zero or more impact factors to the classification level. The method additionally comprises assigning the selected classification level to a piece of information.

A system for classifying information, comprises means for assigning an impact level to at least one impact factor of a group of at least four impact factors that includes confidentiality, legal applicability, integrity, and availability; means for creating a set of zero or more impact factors of the group of at least four impact factors that have greater than a predetermined impact level; means for selecting a classification level based at least in part upon a mapping of the created set of zero or more impact factors to the classification level; and means for assigning the selected classification level to a piece of information.

In accordance with yet another embodiment, a method for classifying information, comprises a step for choosing an impact level for at least one impact factor of a group of at least four impact factors that includes confidentiality, legal applicability, integrity, and availability; a step for creating a set of zero or more impact factors of the group of at least four impact factors that have greater than a predetermined impact level; a step for selecting a classification level based at least in part upon a mapping of the created set of zero or more impact factors to the classification level; and a step for assigning the selected classification level to a piece of information.

An information classification system comprises an impact factor and a classification level. The impact factor is of an impact factor group that includes confidentiality, legal applicability, integrity, and availability. The classification level is of a classification level group that is associated with a set of zero or more impact factors from the impact factor group. Inclusion of each impact factor in the set of zero or more impact factors is based at least in part upon a comparison of an impact level associated with the impact factor to a predetermined impact level.

### BRIEF DESCRIPTION OF THE DRAWINGS

FIG. 1 is a system block diagram of a data classification system;

FIG. 2 is a system block diagram of a classified piece of information;

FIG. 3 is a system block diagram of a computer-implemented classification system;

FIG. 4 is a system block diagram of an exemplary computing system;

FIG. 5 is a schematic block diagram of a sample networked computing environment;

FIG. 6A is a flow diagram of a method of classifying information; and

FIG. 6B is a flow diagram of a method of classifying information.

### DETAILED DESCRIPTION

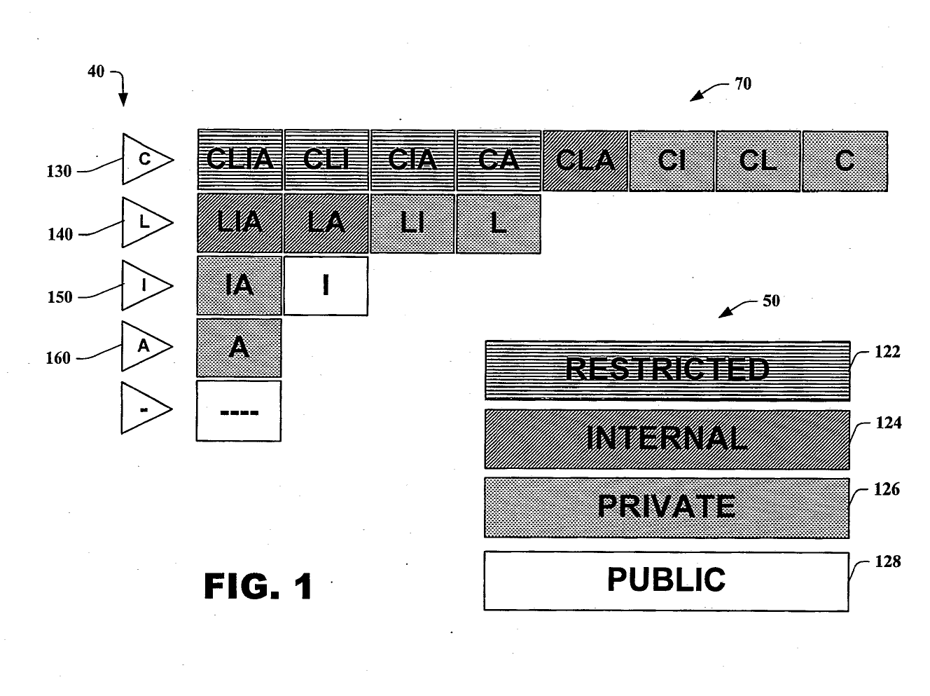

The disclosed and described system, methods, and corresponding operations are described in detail in connection with the views and examples of FIGS. 1-5. Like numbers in figures indicate the same or corresponding elements throughout the views. A data classification system can be provided to classify and control a piece of information. The data classification system may facilitate selection of a classification level for a piece of information. The classification level may indicate the sensitivity of the piece of information, for example, the extent to which the information should be available to others.

In one example and as illustrated by the diagram in FIG. 1, a classification level may be selected for a piece of information, from a group of classification levels, such as the group of classification levels 50. The group of classification levels 50 can include restricted classification level 122, internal classification level 124, private classification level 126, and public classification level 128. The restricted classification level 122 may indicate that the piece of information for which the classification restricted classification level 122 is selected, that is, restricted information, is afforded the highest level of protection. Restricted information may only be disseminated on a “need to know basis”, to named individuals, or to particular groups of people within an organization. Such information may be extremely sensitive, proprietary, legally protected, or confidential. In addition, such information may cause severe harm to an organization due to confidentiality concerns, legal concerns, financial concerns, or competition or market-related concerns. Also, unauthorized or improper disclosure or dissemination of restricted information could severely damage or otherwise harm the reputation or societal standing of the subject of the restricted information or organization possessing restricted information, among others.

An internal classification level 124 may indicate that the information for which the internal classification level 124 is selected, that is, internal information, may not be disseminated outside of a particular organization regardless of whether that information was created by the organization or under the organization's supervision. Unauthorized or improper disclosure or dissemination of internal information could cause serious harm to the organization due to legal concerns, financial concerns, or competition or market-related concerns. Also, serious damage or other harm to the subject of the internal information or organization possessing internal information may occur.

A private classification level 126 may indicate that the information for which the private classification level 126 is selected, that is, private information, may only be accessed by a group that has a legitimate reason to use the information. Such groups may reside within an organization, but may also reside outside of the organization provided that a duty of non-disclosure or confidentiality exists. Such a duty of non-disclosure or confidentiality may be created by means of a signed agreement or contract, by a special relationship such as an attorney-client, accountant-client, or priest-penitent relationship, among others. Unauthorized or improper disclosure or dissemination of private information could cause harm to the organization due to legal concerns, financial concerns, or competition or market-related concerns. Also, damage or other harm to the subject of the private information or organization possessing private information may occur.

A PUBLIC classification level 128 may indicate that the information for which the PUBLIC classification level 128 is selected, that is, public information, may be widely disseminated both inside and outside of an organization. Unauthorized or improper disclosure or dissemination of public information would likely cause little or no harm to the organization. Many forms of information that properly can be classified as public may in fact be intended for public dissemination. Even so, an organization may be concerned with the timing of such disclosure or dissemination or with the accuracy or non-alteration of such information.

Classification levels such as the classification levels shown in the group of classification levels 50 can take on a variety of value types and values within those types. These types can include numeric, alphabetic, alphanumeric, or binary descriptors. For example, the label “restricted” used for the restricted classification level 122 could instead be labeled as “top secret” or labeled with another desired term.

Also, any one of an appropriate variety of classification levels, for example, secret or top secret, can be used to classify a piece of information and any of a variety of suitable criteria may be used for such classifications, for example, classification levels tailored to individual organizations. The classification levels presented here have been described with respect to a generic organization, but it should be understood that the classification levels may be provided for any of a variety of entities, for example, a group or individual person. It should be noted that different entities or organizations can have varying classification needs and can handle different types of information. For instance, an educational institution such as a college or university may possess different information than does the research department of a software development company. Both these organizations in turn may have different information than a healthcare organization such as a hospital, a physician's office, or insurance company. The data classification system disclosed and described here can be adapted to meet particular data classification needs of a specific organization.

The data classification system can associate impact factors to a piece of information or can use impact factors to select a classification level to be applied to a piece of information. The impact factors can be considered in the selection and assignment of particular classification levels to the piece of information. An individual impact factor may represent a concern that affects the classification level of a piece of information. In one example and as illustrated in FIG. 1, a group of impact factors (“CLIA factors”) 40 may be provided for a piece of information and may at least include a Confidentiality factor 130, a Legal Applicability or Legal Protection factor 140, an Integrity factor 150, and an Availability factor 160. The Confidentiality factor 130 can represent the concern of keeping a piece of information secret, protecting the information from disclosure to others, or disclosing the information under controlled circumstances, such as to a business partner or under a confidentiality agreement or non-disclosure agreement. The Legal Applicability factor 140 may represent the applicability of specific statutes, regulations, or other laws that protect or regulate collection, storage, use, or disclosure of the piece of information. The Integrity factor 150 may represent a concern of maintaining the authenticity of the information, that is, ensuring that the actual source of the information is the source purported or believed to be the source, or ensuring that the information is not changed in an unauthorized manner. The Availability factor 160 may represent the concern of limiting the access of entities that are outside a specified group to the information, for example, to a group within an organization such as a department or committee, the organization itself, or the organization and entities outside the organization.

A level of impact may be assigned to an impact factor to indicate the importance of the impact factor in determining the sensitivity of the piece of information. In one example, HIGH or LOW levels of impact may be assigned to at least one of the CLIA factors 130, 140, 150, 160. A HIGH level of impact assigned to one of the CLIA factors 130, 140, 150, 160 can indicate that the factor is important in determining the sensitivity of a piece of information. Conversely, a LOW level of impact assigned to one of the CLIA factors 130, 140, 150, 160 can indicate that the factor is less important in determining the sensitivity or classification level of the piece of information.

A HIGH level of impact assigned to the Confidentiality factor 130 of a piece of information can indicate that confidentiality is important in determining the sensitivity of such information. Unauthorized or improper disclosure or dissemination of information for which confidentiality is a concern can have a HIGH level of impact on the subject or possessor of the information. Examples of information that can have a high level of confidentiality concerns includes consumer credit card account information (including credit applications and credit histories), health care information of identifiable people, research and development information, sensitive financial information, or the like.

A HIGH level of impact assigned to the Legal Applicability factor 140 of a piece of information can indicate that particular laws, statutes, or regulations are important in determining the sensitivity of such information. Unauthorized or improper disclosure or dissemination of information for which legal applicability or legal protection is a concern can have a high level of impact on the subject or possessor of the information. This impact can include potential civil or criminal liability or loss of legal protection, among other impacts. Examples of such statutes, regulations, and other laws may include federal banking laws such as the federal Gramm-Leach-Bliley Act, federal and state consumer credit or consumer protection laws, the federal Patent Act, federal and state trade secret laws, the Health Insurance Portability and Accountability Act (HIPAA), and rules and regulations created under those laws.

A HIGH level of impact assigned to the Integrity factor 150 of a piece of information may indicate that authenticity is important in determining the sensitivity of such information. Discovery that the actual source of information is not the believed or purported source can have a HIGH level of impact on the subject or possessor of the information. Similarly, discovery that the information has been altered can have a HIGH level of impact on the subject or possessor of the information. Such information can include sales and invoice information, banking information, consumer credit card account information, including applications and credit histories, and information about new inventions, among others.

A HIGH level of impact assigned to the Availability factor 160 may indicate that outside access, which may include access by those outside a defined group, to the piece of information is important in determining the sensitivity of such information. Unauthorized or improper disclosure or dissemination of information for which availability is a concern can have a high level of impact on the subject or possessor of the information. Such information can include health care information of identifiable people, banking information, consumer credit card account information, including applications and histories and information about new inventions, among others.

It should be appreciated that a LOW level of impact assigned to the factors 130, 140, 150, 160 may indicate that the respective concerns are less important in determining the sensitivity of a piece of information. It should also be appreciated that the relationships between and among components of this exemplary data classification system can be altered in ways to suit particular concerns and that equivalent systems can be created. For example, an inverse of the systems presented can be created by reversing the values assigned to impact factors and rearranging relationships between sets of impact factors and classification levels to achieve the same or similar results.

Any suitable ones of a variety of additional impact factors can be associated with a piece of information. Examples of such additional factors include accountability, authentication, or age, among others. It will also be appreciated that any suitable ones of a variety of levels of impact may be assigned to the impact factors to indicate the importance of a particular factor in determining the sensitivity of the piece of information. Examples of such levels of impact include INTERMEDIATE, and NULL, among others. Additionally or alternatively, a numerical scale or a continuum of values can be used.

The impact factors can take on a variety of value types and the levels of impact can be assigned according to a set of rules or evaluation methods. It should be appreciated that a wide variety of implementations are possible depending upon details of specific architectures, target platforms, programming languages, and programming environments, as well as a number of other factors known to those of ordinary skill in the art.

A set of impact factors can be created to facilitate the selection of a classification level as disclosed and described here. Inclusion of the impact factors in the set can be based upon a comparison of the level(s) of impact assigned to each impact factor with a predetermined level of impact. In one example, the predetermined level of impact may be LOW. In such an example, a created set of impact factors may include each impact factor, such as a CLIA factor 130, 140, 150, 160 that is greater than the predetermined LOW level of impact. For example, in an implementation where the only levels of impact are LOW and HIGH, the level of impact that is greater than LOW is HIGH.

In another example, the predetermined impact level may be HIGH. In such an example, a created set of impact factors may include each impact factor, such as a CLIA factor 130, 140, 150, 160 that is less than the predetermined HIGH level of impact. In an implementation having only two levels of impact, the level of impact that is less than HIGH is LOW. It will be appreciated that the predetermined level of impact may be selected to be any appropriate level such as NULL or INTERMEDIATE. It will also be appreciated that any of a variety of comparisons may be made between the levels of impact and the predetermined level of impact to determine inclusion of impact factors in the set of impact factors, for instance, a level of impact exactly matches the predetermined level of impact or a level of impact falls within a predetermined range.

Additionally, it should be noted that for many implementations equivalent sets can be created that are inverses of each other and that the inverse of a set may be created and used. For example, in a two-level system or impact levels (HIGH and LOW), creating a set that includes CLIA factors 130, 140, 150, 160 having greater than a LOW level of impact is equivalent to creating a set that includes CLIA factors 130, 140, 150, 160 having less than a HIGH level of impact.

Combinations of various sets of impact factors can be mapped to at least one classification level. A created set of impact factors for a piece of information can be mapped to a particular classification based upon such a mapping. In one example and as illustrated in FIG. 1, a map 70 can correlate various sets of CLIA factors 130, 140, 150, 160 to particular classification levels, for example RESTRICTED level 122, INTERNAL level 124, PRIVATE level 126, or PUBLIC level 128. The correlation is depicted in Table 1. The correlation using inverse sets is shown in Table 2.

TABLE 1

| Data | | | | | | | |
|---|---|---|---|---|---|---|---|
| Classifications | Sets of Impact Factors | | | | | | |
| Restricted | CLIA | CLI | CIA | CA | | | |
| Internal | CLA | LIA | LA | | | | |
| Private | CI | CL | C | LI | L | IA | A |
| Public | I | (NULL) | | | | | |

TABLE 2

| Data | | | | | | | |
|---|---|---|---|---|---|---|---|
| Classifications | Inverse Sets of Impact Factors | | | | | | |
| Restricted | (NULL) | A | L | LI | | | |
| Internal | I | C | CI | | | | |
| Private | LA | IA | LIA | CA | CIA | CL | CLI |
| Public | CLA | CLIA | | | | | |

The set of CLIA factors 130, 140, 150, 160 created for a piece of information may be matched with the CLIA factors provided on the map 70. The classification that correlates to the set of CLIA factors 130, 140, 150, 160 indicated in the map 70 may be assigned to the piece of information. It will be appreciated that any of a variety of policies or rules may dictate the mapping of particular sets to classification levels. It will also be appreciated that any of a variety of configurations or arrangements of impact factors may be mapped to correlate a classification to a piece of information.

Although the impact factors have been described as unidirectionally mapped to the classification levels, it will be appreciated that the mapping between the impact factors and classification level(s) may be bi-directional. In one example, a classification level may be directly assigned to a piece of information. In such an example, CLIA factors 130, 140, 150, 160 may be thereby assigned to the piece of information based upon a selected classification and according to a particular policy or rule.

In the example presented here, there is a many-to-one mapping of sets of CLIA factors to classification levels. There are a total of 16 sets (including the empty set) of combinations of CLIA factors mapped to four classification levels. Accordingly, more than one set of combinations of CLIA factors can result in the same classification level. It is possible to assign a classification level directly and use a policy to determine which CLIA factors apply to a piece of information. Appropriate policies can include treating confidentiality, legal protection, integrity, and availability as having an order of importance or hierarchy and assigning CLIA factors of the most restrictive combination of factors that can produce that classification level. In this example, it is possible to directly classify a piece of information as internal. Using a most-restrictive policy, the CLIA factors to be assigned would be confidentiality, legal protection, and availability. Other policies, such as a least-restrictive policy or a defined one-to-one mapping of classification levels to CLIA factors can also be used. This approach can be beneficial for application to pieces of information that are similar, such as for classifying a batch of credit applications, among others.

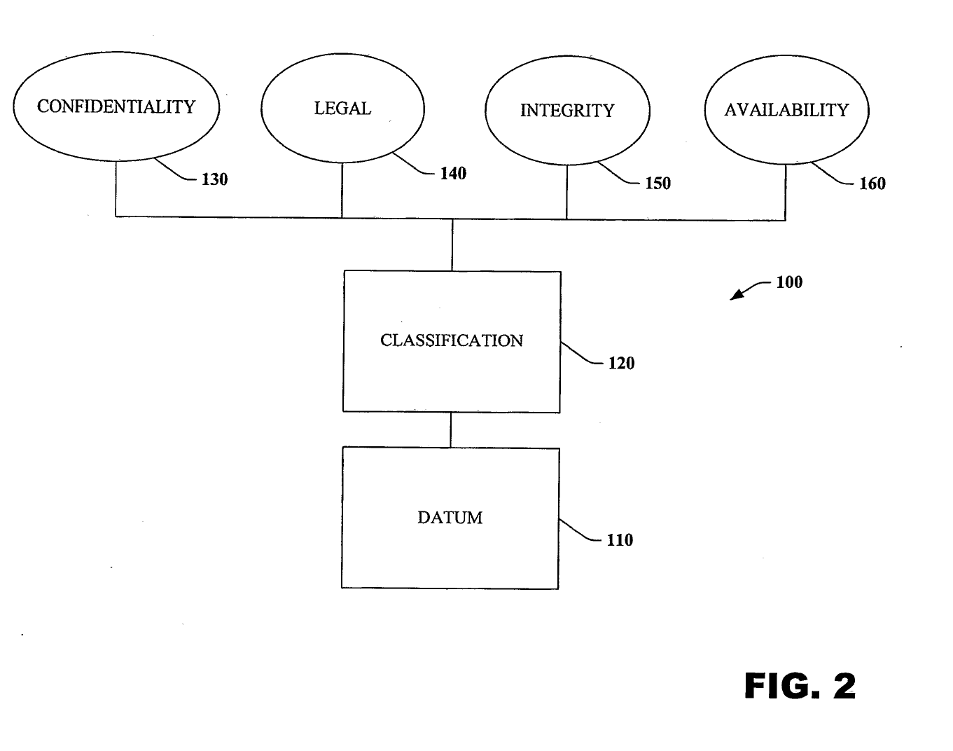

The data classification system described above can be used to classify and control pieces of information 100 in any format. FIG. 2 is a system block diagram of a classified piece of information 100. The classified piece of information may include a datum 110 that includes information in any of a variety of formats (as described below). The classified piece of information 100 may further comprise a classification 120 and impact factors 130, 140, 150 and 160 as described above. In one example, the data classification system can be employed with electronic information. In such an example, the impact factors, levels of impact, and classification levels may be employed as data structures within the electronic information such a fields within objects, encapsulated objects, or dedicated bits, among others. Additionally or alternatively, information about impact factors, levels of impact, and classification levels can be stored or represented in any of a variety of electronic representations such as by appending to a file name or by storing this information in a table in a relational database. Other suitable mechanisms can also be used.

In another example, the data classification system may be employed with paper information. In such an example, the impact factors, levels of impact, and classification levels may be appended to the paper information for example, by using colored tags or labels, colored inks or markers, stamps or embossments, bar codes, or electronic tags such as radio frequency identification (RFID) tags, among other suitable configurations or arrangements. It will be appreciated that the piece of information, datum, classification, and impact factors can be any of a variety of appropriate configurations and arrangements including the examples disclosed above for the data classification system.

The data classification system described above may relate to systems as well as methods for classifying and controlling information. The data classification system and methods may be implemented as part of a computer system. As used in this application, terms “component,” “system,” and the like are intended to refer to a computer-related entity, such as hardware, software in execution or storage, or firmware. For example, a component can be a process running on a processor, a processor, an object, an executable, a program, or a computer. Also, both an application running on a server and the server itself can be components. One or more components can reside within a process and a component can be localized on one computer or distributed between two or more computers.

Artificial intelligence-based systems, for example, explicitly or implicitly trained classifiers can be employed in connection with performing rules-based, inference or probabilistic determinations or statistical-based determinations. As used here, the term “inference” refers generally to the process of reasoning about or inferring states of the system, environment, or user from a set of observations as captured by events or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference can result in the construction of new events or actions from a set of observed events or stored event data, whether or not the events are correlated in close temporal proximity, and whether the events and data come from one or several event and data sources. Various classification schemes or systems, for example, support vector machines, neural networks, expert systems, Bayesian belief networks, fuzzy logic, or data fusion engines can be employed in connection with performing automatic or inferred action in connection with the subject invention.

Furthermore, the data classification system and methods can be implemented as a method, apparatus, or manufacture using standard programming or engineering techniques to produce software, firmware, hardware, or any combination thereof to control a computer. The term “manufacture” as used here is intended to encompass a computer program or data structure accessible from any computer-readable device, carrier, or medium. For example, computer readable media can include but are not limited to magnetic storage devices such as hard disks, floppy disks, magnetic strips, optical disks, smart cards, and flash memory devices. Additionally it should be appreciated that a carrier wave can be employed to carry computer-readable electronic data such as those used in accessing a network such as the Internet or a local area network (LAN). Of course, those skilled in the art will recognize many modifications may be made to this configuration.

It may be evident, however, that the disclosed systems and methods may be practiced without specific details. In other instances, well-known structures and devices are shown in block diagram form in order to facilitate description. Additionally, although specific examples set forth may use terminology that is consistent with client/server architectures or may even be examples of client/server implementations, skilled artisans will appreciate that the roles of client and server may be reversed and that the disclosed systems and methods are not limited to client/server architectures and may be readily adapted for use in other architectures, specifically including peer-to-peer (P2P) architectures.

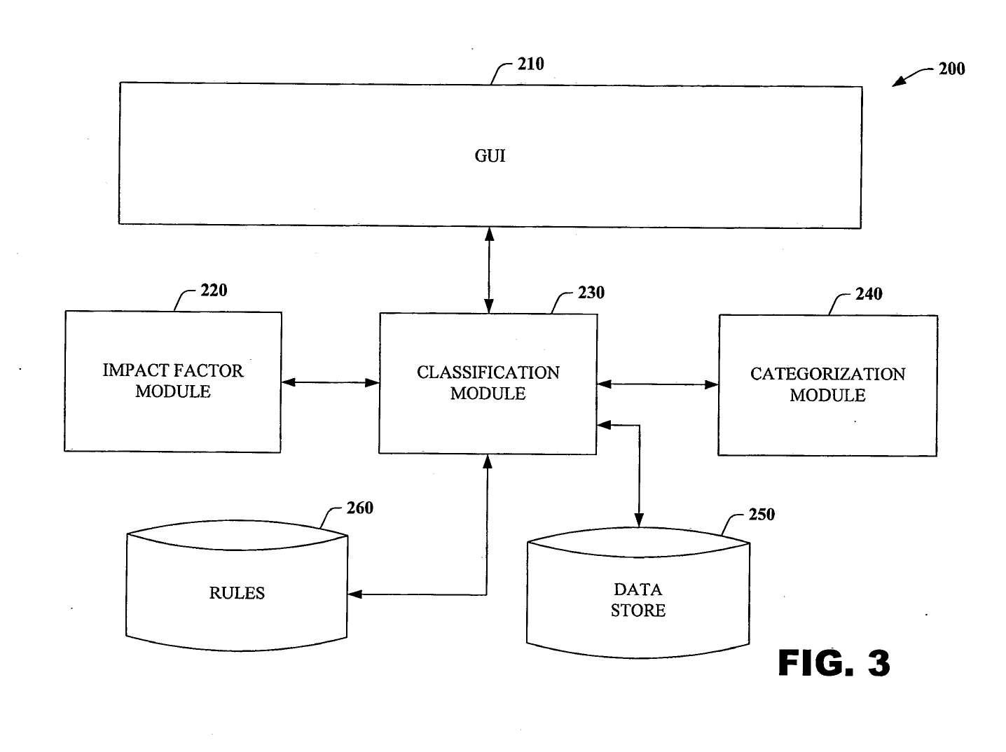

FIG. 3 is a system block diagram of a computer-implemented classification system 200. The computer-implemented data classification system 200 may include a graphical user interface (GUI) 210. The GUI 210 can be any appropriate GUI, including a single-purpose GUI that is part of a stand-alone application, a web-based (HTML) interface, or any of a variety of other appropriate interfaces. The GUI 210 can also be replaced with a text-based interface such as a command line interface (CLI) or a specialized interface such as a speech-based interface or a Braille interface, among others.

The GUI 210 can communicate with an impact factor module 220, a classification module 230, and a categorization module 240 to classify a piece of information from the data store 250. The impact factor module 220 can be used to evaluate and track the use of levels of impact and impact factors for a piece of information. In one example, the impact factor module 220 may receive external information, for example, from a user-based input or computer-generated input indicating a particular of a level of impact for a particular impact factor. In such an example, the impact factor may assign the indicated level of impact from the data store 250 to an impact factor associated with a piece of information. The categorization module 220 can be used to compare the assigned levels of impact from the impact factor module 220 and select an appropriate classification level for the piece of information being classified. In one example, the categorization module 240 may compare the levels of impact from the impact factor module 220 to a predetermined level of impact. In such an example, the categorization module 240 may create sets of impact factors based upon the comparison as described above. The classification module 230 may classify the piece of information based upon rules or policies from the rules store 260.

In one example, the classification module 230 may apply a set of impact factors from the categorization module 240 to the rules or policies from the rules store 260. In such an example, a classification may be applied to the piece of information based upon the set of impact factors and the rules/policies. It will be appreciated that the modules 220, 230 and 240 may be any of a variety of configurations or arrangements for processing data classification. It will also be appreciated that individual modules may be capable of performing any or all of the operations of the modules 220, 230 and 240 above. For example, the classification module 230 can evaluate and track the use of levels of impact and impact factors, compare the levels of impact to a predetermined level of impact and apply rules or policies to assign a classification level to a piece of information.

As mentioned above, the rules data store 260 can include appropriate rules for classifying information. In one example, the rules data store 260 can include a map, such as the map 70 as illustrated in FIG. 1, to determine a classification. In such an example, the classification module 230 may apply a set of CLIA factors, such as the CLIA factors 130, 140, 150, 160 of FIG. 1, associated with a piece of information to the map 70 in the rules data store 260 to assign a classification such as the classification 120 of FIG. 1 to the piece of information. In another example, the rules data store 260 can include rules from external sources such as statutes, rules, regulations, and laws that apply to or otherwise can affect classification of data.

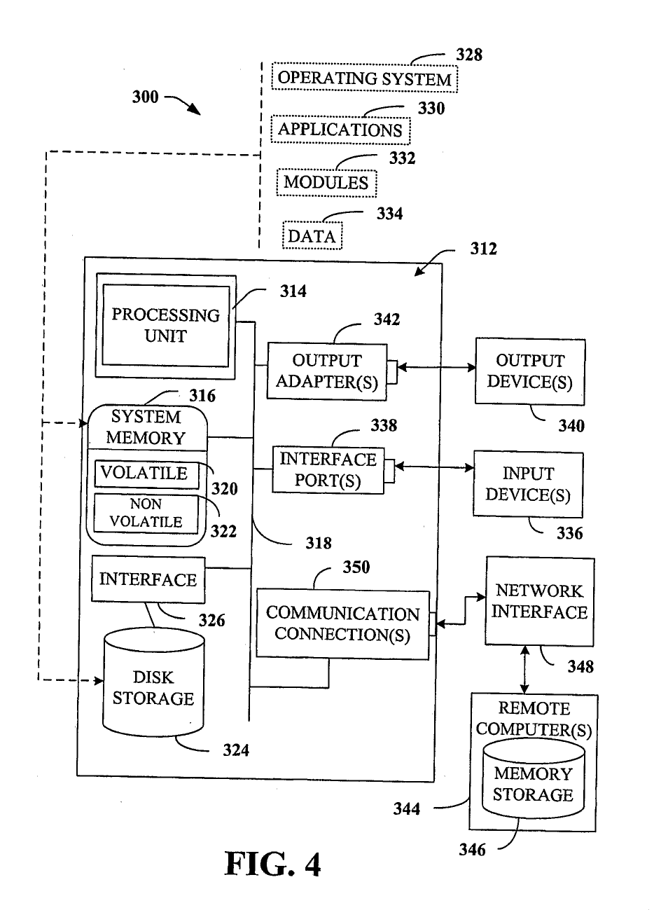

With reference to FIG. 4, an exemplary environment 300 for implementing various components or methods includes a computer 312. The computer 312 includes a processing unit 314, a system memory 316, and a system bus 318. The system bus 318 can couple system components including, but not limited to, the system memory 316 to the processing unit 314. The processing unit 314 can be any of various available processors. Dual microprocessors and other multiprocessor architectures also can be employed as the processing unit 314.

The system bus 318 can be any of several types of bus structure(s) including the memory bus or memory controller, a peripheral bus or external bus, or a local bus using any variety of available bus architectures including, but not limited to, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Card Bus, Universal Serial Bus (USB), Advanced Graphics Port (AGP), Personal Computer Memory Card International Association bus (PCMCIA), Firewire (IEEE 1394), and Small Computer Systems Interface (SCSI).

The system memory 316 includes volatile memory 320 and nonvolatile memory 322. The basic input/output system (BIOS), containing the basic routines to transfer information between elements within the computer 312, such as during start-up, is stored in nonvolatile memory 322. For example, nonvolatile memory 322 can include read only memory (ROM), programmable ROM (PROM), electrically programmable ROM (EPROM), electrically erasable ROM (EEPROM), or flash memory. Volatile memory 320 can include random access memory (RAM), which can acts as external cache memory. For example, RAM is available in many formats such as synchronous RAM (SRAM), dynamic RAM (DRAM), synchronous DRAM (SDRAM), double data rate SDRAM (DDR/SDRAM), enhanced SDRAM (ESDRAM) Synchlink DRAM (SLDRAM), and direct Rambus RAM (DRRAM).

Computer 312 also includes removable/non-removable, volatile/non-volatile computer storage media. For example, FIG. 4 illustrates a disk storage 324. The disk storage 324 includes, but is not limited to, devices like a magnetic disk drive, floppy disk drive, tape drive, Jaz drive, Zip drive, LS-1 00 drive, flash memory card, or memory stick. In addition, disk storage 324 can include storage media separately or in combination with other storage media including, but not limited to, an optical disk drive such as a compact disk ROM device (CDROM), CD recordable drive (CD-R Drive), CD rewritable drive (CD-RW Drive) or a digital versatile disk ROM drive (DVD-ROM). To facilitate connection of the disk storage devices 324 to the system bus 318, a removable or non-removable interface can be used such as interface 326.

It is to be appreciated that FIG. 4 describes software that can act as an intermediary between users and the basic computer resources described in the suitable operating environment 300. Such software includes an operating system 328. The operating system 328, which can be stored on the disk storage 324, acts to control and allocate resources of the computer system 312. System applications 330 take advantage of the management of resources by operating system 328 through program modules 332 and program data 334 stored either in system memory 316 or on disk storage 324. It is to be appreciated that the disclosed systems and methods can be implemented with various operating systems or combinations of operating systems.

A user enters commands or information into the computer 312 through input device(s) 336. The input devices 336 include, but are not limited to, a pointing device such as a mouse, trackball, stylus, touch pad, keyboard, microphone, joystick, game pad, satellite dish, scanner, TV tuner card, digital camera, digital video camera, web camera, and the like. These and other input devices connect to the processing unit 314 through the system bus 318 via interface port(s) 338. Interface port(s) 338 include, for example, a serial port, a parallel port, a game port, and a universal serial bus (USB). Output device(s) 340 use some of the same type of ports as input device(s) 336. Thus, for example, a USB port may be used to provide input to computer 312 and to output information from computer 312 to an output device 340. Output adapter 342 is provided to illustrate that there are some output devices 340 like monitors, speakers, and printers, among other output devices 340, which require special adapters. The output adapters 342 include, by way of illustration and not limitation, video and sound cards that provide a means of connection between the output device 340 and the system bus 318. It should be noted that other devices and/or systems of devices provide both input and output capabilities such as remote computer(s) 344.

Computer 312 can operate in a networked environment using logical connections to one or more remote computers, such as remote computer(s) 344. The remote computer(s) 344 can be a personal computer, a server, a router, a network PC, a workstation, a microprocessor based appliance, a peer device or other common network node and the like, and typically includes many or all of the elements described relative to computer 312. For purposes of brevity, only a memory storage device 346 is illustrated with remote computer(s) 344. Remote computer(s) 344 is logically connected to computer 312 through a network interface 348 and then physically connected via communication connection 350. Network interface 348 encompasses wire and/or wireless communication networks such as local-area networks (LAN) and wide-area networks (WAN). LAN technologies include Fiber Distributed Data Interface (FDDI), Copper Distributed Data Interface (CODI), Ethernet, Token Ring and the like. WAN technologies include, but are not limited to, point-to-point links, circuit switching networks like Integrated Services Digital Networks (ISDN) and variations thereon, packet switching networks, and Digital Subscriber Lines (DSL).

Communication connection(s) 350 refers to the hardware/software employed to connect the network interface 348 to the bus 318. While communication connection 350 is shown for illustrative clarity inside computer 312, it can also be external to computer 312. The hardware/software necessary for connection to the network interface 348 includes, for exemplary purposes only, internal and external technologies such as, modems including regular telephone grade modems, cable modems and DSL modems, ISDN adapters, and Ethernet cards.

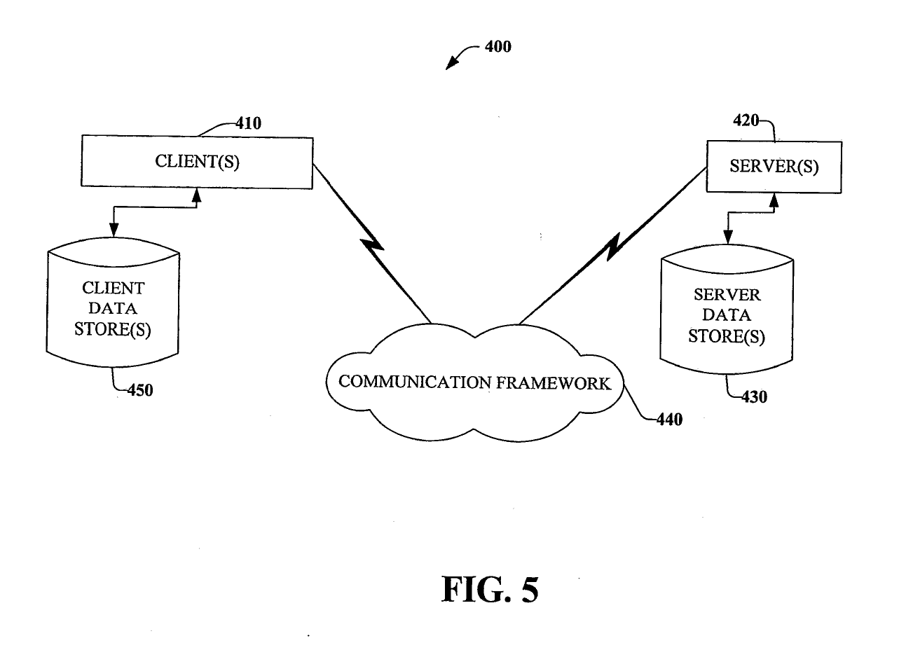

FIG. 5 is a schematic block diagram of a sample-computing environment 400 with which the disclosed systems or computer-implemented methods can interact. The system 400 includes one or more client(s) 410. The client(s) 410 can be hardware and/or software, for example, threads, processes, or computing devices. The system 400 also includes one or more server(s) 420. The server(s) 420 can be hardware and/or software, for example, threads, processes, or computing devices. The servers 420 can house threads or processes to perform transformations by employing the disclosed systems or methods, for example.

One possible means of communication between a client 410 and a server 420 can be in the form of a data packet adapted to be transmitted between two or more computer processes. The system 400 includes a communication framework 440 that can be employed to facilitate communications between the client(s) 410 and the server(s) 420. The client(s) 410 are operably connected to one or more client data store(s) 450 that can be employed to store information local to the client(s) 410. Similarly, the server(s) 420 are operably connected to one or more server data store(s) 430 that can be employed to store information local to the servers 440.

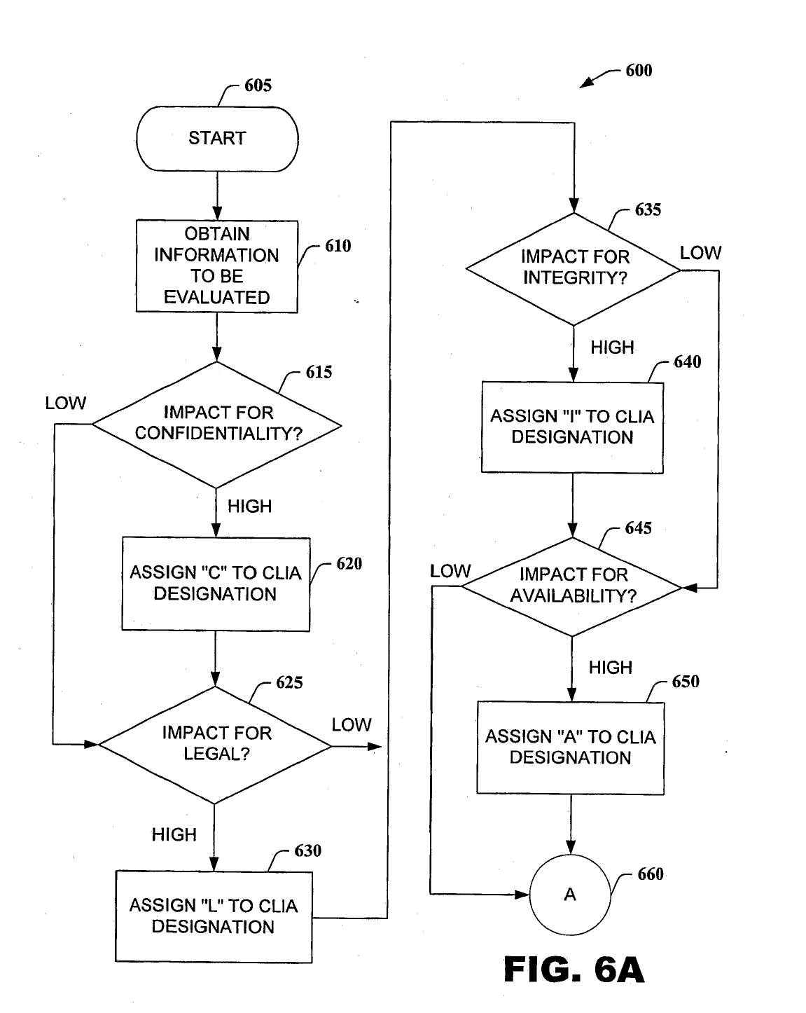

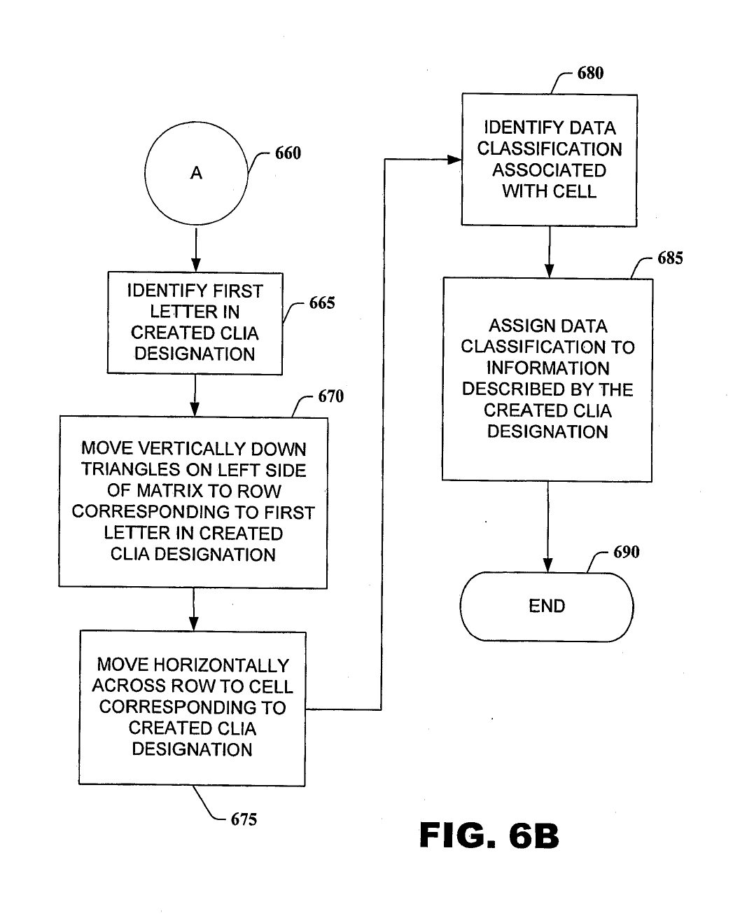

FIGS. 6A and 6B are a flow chart diagram depicting an example of a method of data classification. Performance of the method begins at START block 605 and continues to process block 610 where information is obtained to be evaluated. At decision block 615 a determination is made whether the impact level assigned to the confidentiality factor is HIGH or LOW. If the impact level is HIGH, performance of the method continues to process block 620 to assign a “C” to a set of CLIA factors. Performance of the method then continues to decision block 625. If the impact level is LOW, performance of the method proceeds to decision block 625.

At decision block 625 a determination is made whether the impact level assigned to the legal protection factor is HIGH or LOW. If the impact level is HIGH, performance of the method continues to process block 630 to assign an “L” to the set of CLIA factors. Performance of the method then continues to decision block 635. If the impact level is LOW, performance of the method proceeds to decision block 635.

At decision block 635 a determination is made whether the impact level assigned to the integrity factor is HIGH or LOW. If the impact level is HIGH, performance of the method continues to process block 640 to assign an “I” to the set of CLIA factors. Performance of the method then continues to decision block 645. If the impact level is LOW, performance of the method proceeds to decision block 645.

At decision block 645 a determination is made whether the impact level assigned to the availability factor is HIGH or LOW. If the impact level is HIGH, performance of the method continues to process block 650 to assign an “A” to the set of CLIA factors. Performance of the method then continues to continuation block 655. If the impact level is LOW, performance of the method proceeds to continuation block 660.

Performance of the method continues from continuation block 660 to process block 665 where the first letter assigned to the set of CLIA factors is identified. At process block 670, the first letter in the set of CLIA factors is compared to the indicators that are provided vertically along the left of the map 70 of FIG. 1. When the first letter of the set of CLIA factors is matched to the first letter indicator, performance of the method continues to process block 675 where the letters in the set of CLIA factors are matched with the indicators in a cell that is located in the same horizontal row as the first letter indicator. At process block 680, the classification associated with the cell is identified and at process block 685, the classification is assigned to the piece of information associated with the set of CLIA factors. Performance of the method terminates at END block 690.

What has been described above includes examples. It is, of course, not possible to describe every conceivable combination of components or methods, but one of ordinary skill in the art may recognize that many further combinations and permutations of the disclosed and described systems and methods are possible. Accordingly, the disclosed and described systems and methods are intended to embrace all such alterations, modifications, and variations that fall within the spirit and scope of the appended claims.

In particular and in regard to the various functions performed by the above described components, devices, circuits, systems and the like, the terms used to describe such components are intended to correspond, unless otherwise indicated, to any component which performs the specified function of the described component, such as a functional equivalent, even though not structurally equivalent to the disclosed structure, which performs the function. In this regard, it will also be recognized that the disclosed systems and methods include a system as well as a computer-readable medium having computer-executable instructions for performing the acts or events of the various methods. In addition, while a particular feature may have been disclosed with respect to only one of several implementations, such feature may be combined with one or more other features of the other implementations as may be desired for any given or particular application.

The foregoing description has been presented to illustrate and describe. It is not intended to be exhaustive or a complete listing of various implementations or configurations of the disclosed and described components. Many modifications are possible. Some of those modifications have been discussed, and others will be understood by those skilled in the art.

We claim:

1. A system for classifying information, comprising:
a group of at least four impact factors that includes confidentiality, legal applicability, integrity, and availability (130,140,150,160);
an impact level assigned to at least one impact factor in the group of at least four impact factors; and
a classification level based upon a set of zero or more impact factors from the group of at least four impact factors;
wherein inclusion of each impact factor in the set of zero or more impact factors is based at least in part upon a comparison of the impact level assigned to each impact factor to a predetermined impact level.

2. The system of claim 1, wherein each member of the set of zero or more impact factors is mapped to at least one classification level.

3. The system of claim 1, wherein the impact level is an impact level chosen from the group that includes a high impact level and a low impact level.

4. The system of claim 3, wherein the predetermined impact level is a high impact level.

5. The system of claim 4, wherein the classification level is restricted (122).

6. The system of claim 5, wherein the set of zero or more impact factors includes confidentiality (130).

7. The system of claim 5, wherein the set of zero or more impact factors includes legal applicability (140).

8. The system of claim 5, wherein the set of zero or more impact factors includes integrity (150).

9. The system of claim 5, wherein the set of zero or more impact factors includes availability (160).

10. The system of claim 4, wherein the classification level is internal (124).

11. The system of claim 10, wherein the set of zero or more impact factors includes confidentiality (130).

12. The system of claim 10, wherein the set of zero or more impact factors includes legal applicability (140).

13. The system of claim 10, wherein the set of zero or more impact factors includes integrity (150).

14. The system of claim 10, wherein the set of zero or more impact factors includes availability (160).

15. The system of claim 4, wherein the classification level is private (126).

16. The system of claim 15, wherein the set of zero or more impact factors includes confidentiality (130).

17. The system of claim 15, wherein the set of zero or more impact factors includes legal applicability (140).

18. The system of claim 15, wherein the set of zero or more impact factors includes integrity (150).

19. The system of claim 15, wherein the set of zero or more impact factors includes availability (160).

20. The system of claim 4, wherein the classification level is public (128).

21. The system of claim 20, wherein the set of zero or more impact factors includes confidentiality (130).

22. The system of claim 20, wherein the set of zero or more impact factors includes legal applicability (140).

23. The system of claim 20, wherein the set of zero or more impact factors includes integrity (150).

24. The system of claim 20, wherein the set of zero or more impact factors includes availability (160).

25. A data structure for storing classified data, comprising:
an information field configured to store classified information;
a classification field configured to store an indicator of a classification assigned to the classified information; and
a factor field configured to store at least one indicator of an impact factor that is selected from a group that includes confidentiality, legal protection, integrity, and availability (130,140,150,160) and that is associated with the classification assigned to the classified information.

26. The data structure of claim 25, wherein the classification field includes the factor field.

27. A computer-readable medium comprising:
a data structure for storing classified data including
an information field configured to store classified information;
a classification field configured to store an indicator of a classification assigned to the classified information; and
a factor field configured to store at least one indicator of an impact factor that is selected from a group that includes confidentiality, legal protection, integrity, and availability (130,140,150,160) and that is associated with the classification assigned to the classified information.

28. A manufacture comprising:
a data signal, embodied in a communication medium, that includes
a data structure for storing classified data including
an information field configured to store classified information;
a classification field configured to store an indicator of a classification assigned to the classified information; and
a factor field configured to store at least one indicator of an impact factor that is selected from a group that includes confidentiality, legal protection, integrity, and availability (130,140,150,160) and that is associated with the classification assigned to the classified information.

29. The manufacture of claim 28, wherein the communication medium includes a radio frequency carrier wave.

30. The manufacture of claim 28, wherein the communication medium includes a fiber optic line.

31. The manufacture of claim 28, wherein the communication medium includes a wire.

32. A system for classifying information in electronic formats, comprising:
an impact factor module (220) configured to provide a designation of zero or more impact factors associated with a piece of information;
a categorization module (240) in data communication with the impact factor module that is configured to select a classification for the piece of information based at least in part upon the designation of zero or more impact factors; and
a classification module (230) configured to assign a selected classification to a piece of information.

33. The system of claim 32, further comprising a designation of zero or more impact factors from a group of impact factors that includes confidentiality, legal protection, integrity, and availability (130,140,150,160).

34. The system of claim 33, further comprising a set of classifications that includes restricted, internal, private, and public (122, 124, 126, 128).

35. The system of claim 34, wherein the classification module (230) is further configured to access a rules base (260) that includes rules for classifying information.

36. The system of claim 35, wherein the classification module (230) is further configured to access a data store (250).

37. The system of claim 36, further comprising a graphical user interface (210) configured to provide access to the classification module (230).

38. A method for classifying information, comprising:
assigning an impact level to at least one impact factor of a group of at least four impact factors that includes confidentiality, legal applicability, integrity, and availability (130,140,150,160);
creating a set of zero or more impact factors of the group of at least four impact factors that have greater than a predetermined impact level;
selecting a classification level based at least in part upon a mapping of the created set of zero or more impact factors to the classification level; and
assigning the selected classification level to a piece of information.

39. The method of claim 38, wherein assigning an impact level to at least one impact factor includes assigning an impact level for each of the impact factors of the group of at least four impact factors.

40. The method of claim 39, wherein assigning an impact level for each of the impact factors of the group of at least four impact factors includes selecting the impact level from a group of impact levels that includes a high impact level and a low impact level.

41. The method of claim 40, wherein creating a set of zero or more impact factors includes selecting an impact factor that is assigned a high impact level.

42. The method of claim 41 wherein selecting a classification level includes accessing a set of mappings of zero or more impact factors to at least one classification level.

43. The method of claim 42, wherein assigning the selected classification level includes assigning a restricted (122) classification.

44. The method of claim 42, wherein assigning the selected classification level includes assigning an internal (124) classification.

45. The method of claim 42, wherein assigning the selected classification level includes assigning a private (126) classification.

46. The method of claim 42, wherein assigning the selected classification level includes assigning a public (128) classification.

47. The method of claim 38, wherein selecting a classification level based at least in part upon a mapping of the created set of zero or more impact factors to the classification level includes selecting a classification level from a group of classification levels that includes restricted, internal, private, and public (122, 124, 126, 128).

48. A system for classifying information, comprising:
means for assigning an impact level to at least one impact factor of a group of at least four impact factors that includes confidentiality, legal applicability, integrity, and availability (130,140,150,160);
means for creating a set of zero or more impact factors of the group of at least four impact factors that have greater than a predetermined impact level;
means for selecting a classification level based at least in part upon a mapping of the created set of zero or more impact factors to the classification level; and
means for assigning the selected classification level to a piece of information.

49. The system of claim 48, wherein the means for assigning an impact level to at least one impact factor includes means for assigning an impact level for each of the impact factors of the group of at least four impact factors.

50. The system of claim 49, wherein the means for assigning an impact level for each of the impact factors of the group of at least four impact factors includes means for selecting the impact level from a group of impact levels that includes a high impact level and a low impact level.

51. The system of claim 50, wherein the means for creating a set of zero or more impact factors includes means for selecting an impact factor that is assigned a high impact level.

52. The system of claim 51 wherein the means for selecting a classification level includes means for accessing a set of mappings of zero or more impact factors to at least one classification level.

53. The system of claim 52, wherein the means for assigning the selected classification level includes means for assigning a restricted classification (122).

54. The system of claim 52, wherein the means for assigning the selected classification level includes means for assigning an internal classification (124).

55. The system of claim 52, wherein the means for assigning the selected classification level includes means for assigning a private classification (126).

56. The system of claim 52, wherein the means for assigning the selected classification level includes means for assigning a public classification (128).

57. A method for classifying information, comprising:
a step for choosing an impact level for at least one impact factor of a group of at least four impact factors that includes confidentiality, legal applicability, integrity, and availability (130,140,150,160);
a step for creating a set of zero or more impact factors of the group of at least four impact factors that have greater than a predetermined impact level;
a step for selecting a classification level based at least in part upon a mapping of the created set of zero or more impact factors to the classification level; and
a step for assigning the selected classification level to a piece of information.

58. The method of claim 57, wherein the step for choosing an impact level for at least one impact factor includes a step for assigning an impact level for each of the impact factors of the group of at least four impact factors.

59. The method of claim 58, wherein the step for assigning an impact level for each of the impact factors of the group of at least four impact factors includes a step for selecting the impact level from a group of impact levels that includes a high impact level and a low impact level.

60. The method of claim 59, wherein the step for creating a set of zero or more impact factors includes a step for selecting an impact factor that is assigned a high impact level.

61. The method of claim 60 wherein the step for selecting a classification level includes a step for accessing a set of mappings of zero or more impact factors to at least one classification level.

62. The method of claim 61, wherein the step for assigning the selected classification level includes a step for assigning a restricted classification (122).

63. The method of claim 61, wherein the step for assigning the selected classification level includes a step for assigning an internal classification (124).

64. The method of claim 61, wherein the step for assigning the selected classification level includes a step for assigning a private classification (126).

65. The method of claim 61, wherein the step for assigning the selected classification level includes a step for assigning a public classification (128).

66. The method of claim 57, wherein the step for selecting a classification level based at least in part upon a mapping of the created set of zero or more impact factors to the classification level includes a step for selecting a classification level from a group of classification levels that includes restricted, internal, private, and public (122, 124, 126, 128).

67. An information classification system, comprising
an impact factor of an impact factor group that includes confidentiality, legal applicability, integrity, and availability (130,140,150,160); and
a classification level of a classification level group that is associated with a set of zero or more impact factors from the impact factor group;
wherein inclusion of each impact factor in the set of zero or more impact factors is based at least in part upon a comparison of an impact level associated with the impact factor to a predetermined impact level.

68. The system of claim 67, wherein the classification level is restricted (122).

69. The system of claim 68, wherein the set of impact factors comprises confidentiality (130).

70. The system of claim 68, wherein the set of impact factors comprises legal protection (140).

71. The system of claim 68, wherein the set of impact factors comprises integrity (150).

72. The system of claim 68, wherein the set of impact factors comprises availability (160).

73. The system of claim 67, wherein the classification level is internal (124).

74. The system of claim 73, wherein the set of impact factors comprises confidentiality (130).

75. The system of claim 73, wherein the set of impact factors comprises legal protection (140).

76. The system of claim 73, wherein the set of impact factors comprises integrity (150).

77. The system of claim 73, wherein the set of impact factors comprises availability (160).

78. The system of claim 67, wherein the classification level is private (126).

79. The system of claim 78, wherein the set of impact factors comprises confidentiality (130).

80. The system of claim 78, wherein the set of impact factors comprises legal protection (140).

81. The system of claim 78, wherein the set of impact factors comprises integrity (150).

82. The system of claim 78, wherein the set of impact factors comprises availability (160).

83. The system of claim 67, wherein the classification level is public (128).

84. The system of claim 83, wherein the set of impact factors comprises integrity (150).

85. The system of claim 83, wherein the set of impact factors is empty.
